(19) United States
(12) Patent Application Publication
(10) Pub. No.: US 2014/0026821 A1
(43) Pub. Date: Jan. 30, 2014

(54) PET GROOMING TOOL HAVING OFFSET BLADE DESIGN

(71) Applicant: Hua Tu, Homei Town (TW)

(72) Inventor: Hua Tu, Homei Town (TW)

(21) Appl. No.: 13/557,958

(22) Filed: Jul. 25, 2012

(51) Int. Cl. A01K 13/00

(52) U.S. Cl. 119/600

(57) ABSTRACT

A pet grooming tool includes a handle having a proximate end on which is mounted a set of rear blades and a set of forward blades. The rear blades are interleaved with the forward blades. Each blade includes a hooked end having a curved, outer tip which is unsharpened, and an inset sharpened blade edge. The rear blades and forward blades are offset in both a forward-to-rear orientation and a side-to-side orientation to cause the fur or hair of the animal being groomed to form a soft “S” shape or bend over the sharpened blade edges.

### BACKGROUND OF THE INVENTION

1. Field of the Invention

The present invention generally relates to pet grooming tools, and more particularly relates to devices for deshedding and dematting the fur of dogs and other pets.

2. Description of the Prior Art

There are several different pet grooming tools currently on the market, one of which is referred to by the trademark FURMINATOR®. There are also a number of pet grooming tools known in the art, as evidenced by design U.S. Pat. Nos. D626,297; D626,296; and D626,295, and utility U.S. Pat. Nos. 7,717,067; 7,650,858; 7,650,857; 7,509,926; 7,334,540; 7,222,588; and 7,077,076, each of the aforementioned patents issuing to David R. Porter or David R. Porter and Angela L. Porter. The FURMINATOR® pet grooming tool and the grooming tools disclosed in the aforementioned patents are used to remove loose fur or hair from pets, such as a dog or a cat. Although these conventional pet grooming tools may be suitable for their intended purpose, it is believed they are not as efficient as they could be in deshedding and dematting the fur or hair of a pet.

### OBJECTS AND SUMMARY OF THE INVENTION

It is an object of the present invention to provide a pet grooming tool which is highly efficient in deshedding and dematting the fur or hair of a pet.

It is another object of the present invention to provide a pet grooming tool which has an offset blade design that more easily catches the hair of a pet.

It is still another object of the present invention to provide an offset blade design for a pet grooming tool which will not irritate or harm the skin of the pet when used.

It is a further object of the present invention to provide a pet grooming tool and an offset blade design for a pet grooming tool which increase blade edge contact with the fur or hair of the pet being groomed.

It is yet a further object of the present invention to provide a multiple blade design for a pet grooming tool which increases the surface area that may contact the animal's fur for deshedding or dematting the animal.

In one form of the present invention, a pet grooming tool includes a handle formed as an elongated body for grasping by the user. At one end of the body is mounted a plurality of blades offset from each other in both a forward and rear orientation and a side-to-side orientation. Each blade has an unsharpened, curved hooked end or outer tip which may make contact with the skin of the animal and protects the skin from the blade edge. Set inwardly of this outer tip or hooked end on each blade is a sharpened edge which will not contact the skin of the animal but rather only contacts the fur or hair. The particular forward/rear orientation and side-to-side orientation of the plurality of blades force the fur or hair of the animal when being groomed to form a soft “S” shape or bend over the sharpened edges of the forward and rear offset blade. This soft “S” shape or bend of the hair causes the hair to catch more easily on the inset blade edges.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a front perspective view of a pet grooming tool formed in accordance with the present invention.

FIG. 2 is a rear perspective view of the pet grooming tool of the present invention shown in FIG. 1.

FIG. 3 is an exploded front perspective view of the pet grooming tool of the present invention shown in FIG. 1.

FIG. 4 is an enlarged, front perspective view of an offset blade design for use in a pet grooming tool formed in accordance with the present invention.

FIG. 5 is a perspective view taken from a first side of a single forward blade of the blade design of the present invention.

FIG. 6 is a perspective view taken from a second side of a single forward blade of the blade design of the present invention.

FIG. 7 is a perspective view taken from a first side of a single rear blade of the blade design of the present invention.

FIG. 8 is a perspective view taken from a second side of a single rear blade of the blade design of the present invention.

FIG. 9 is a perspective view of a pair of forward and rear blades of the blade design of the present invention and illustrating how during grooming a hair of the animal is forced to form a soft “S” shape or bend as it passes over the rear and forward blades.

FIG. 10 is a front perspective view of a pet grooming tool constructed in accordance with another form of the present invention.

FIG. 11 is a rear perspective view of the alternative form of the pet grooming tool of the present invention shown in FIG. 10.

FIG. 12 is an exploded front perspective view of the alternative form of the pet grooming tool of the present invention shown in FIG. 10.

FIG. 13 is a perspective view taken from a first side of a single blade of the blade design of the present invention used in the pet grooming tool shown in FIG. 10.

FIG. 14 is a perspective view taken from a second side of the single blade of the blade design of the present invention shown in FIG. 10.

### DETAILED DESCRIPTION OF THE PREFERRED EMBODIMENTS

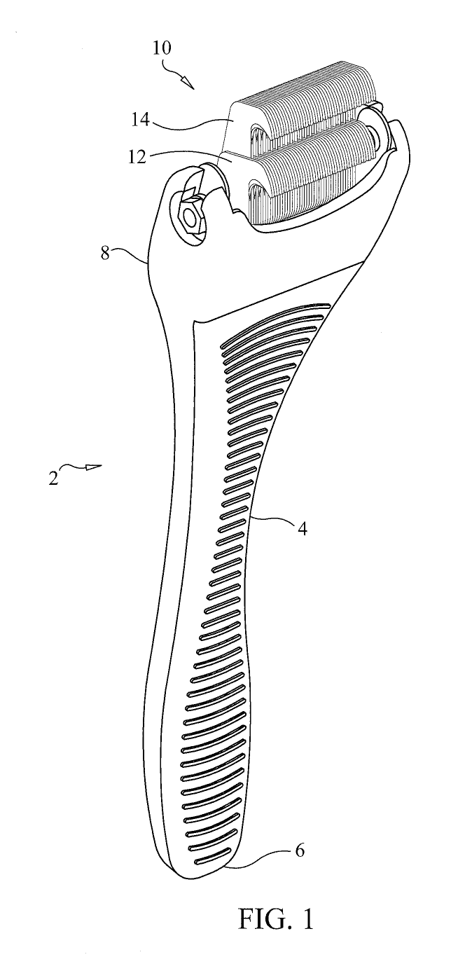

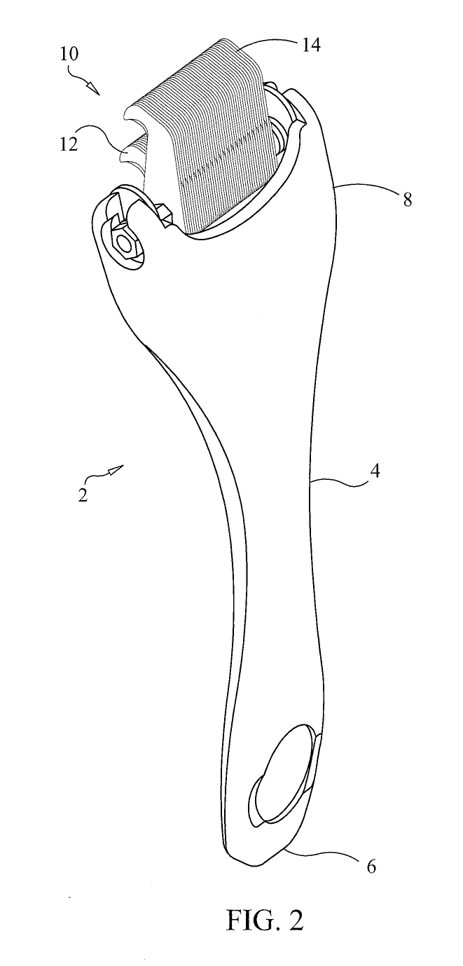

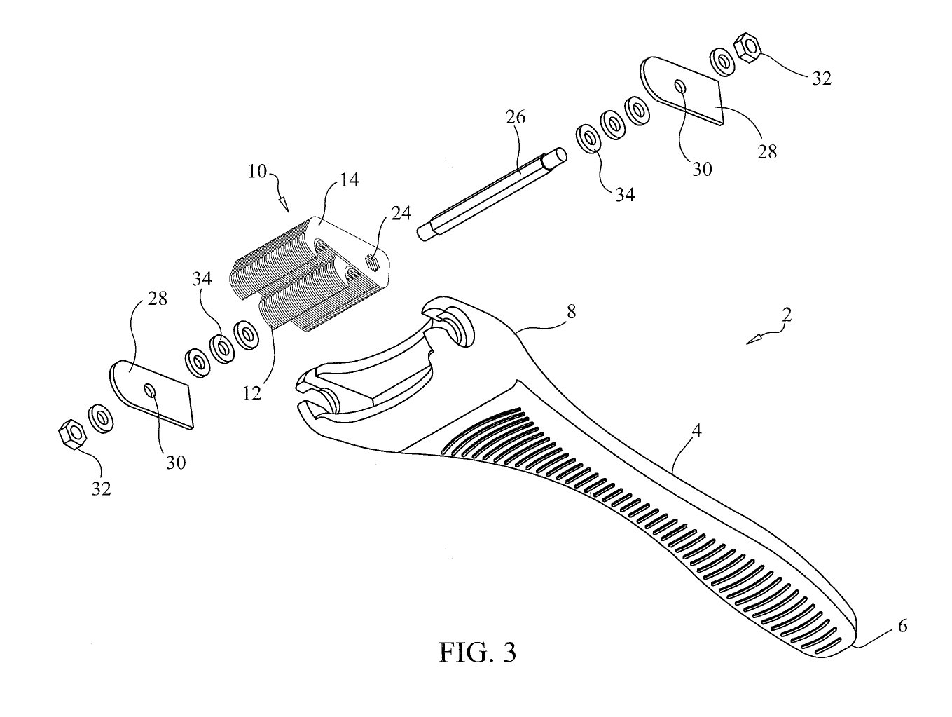

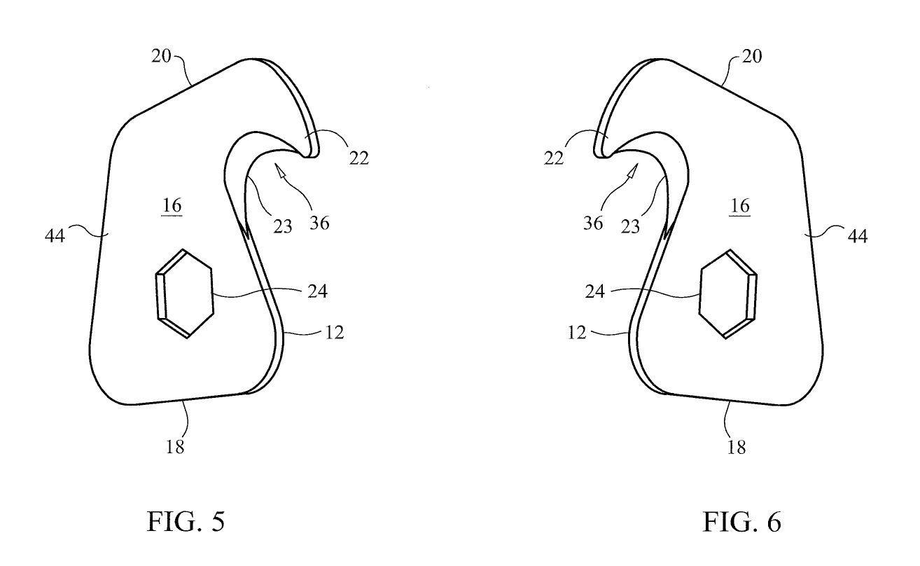

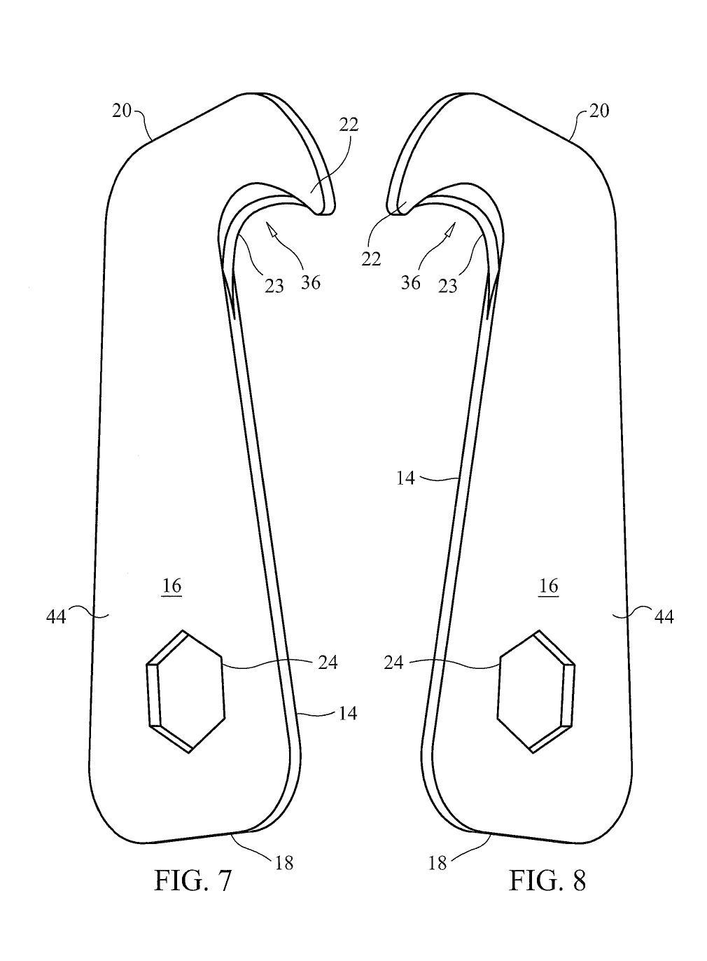

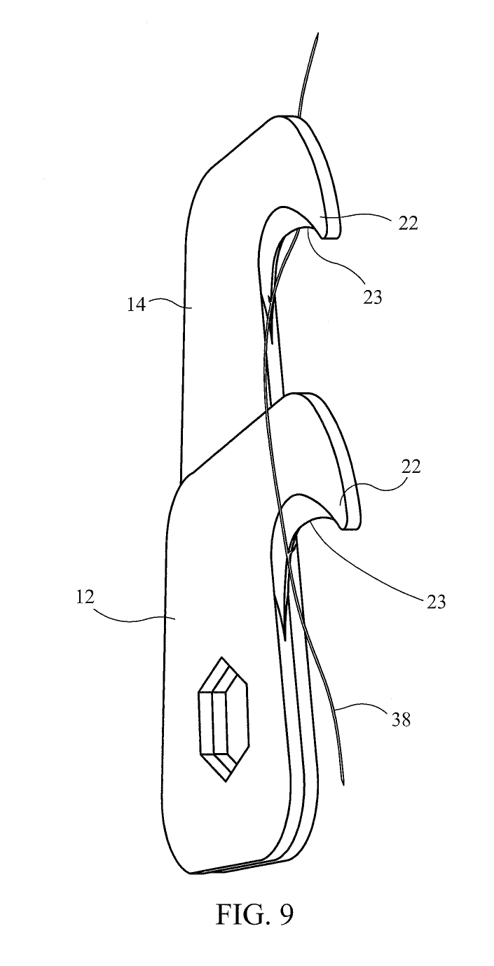

Referring initially to FIGS. 1-9 of the drawings, it will be seen that a pet grooming tool 2 constructed in accordance with one form of the present invention includes a handle 4 for grasping by the user of the pet grooming tool. The handle 4 is preferably formed as an elongated body having a distal end 6 and an opposite proximate end 8. Mounted on the proximate end 8 of the pet grooming tool is a blade assembly 10.

In the first form of the pet grooming tool 2 of the present invention, the blade assembly 10 includes a plurality of interleaved sets of forward and rear blades 12, 14. Each of the forward and rear blades 12, 14 includes a main body 16 having a lower end 18 and opposite upper end 20. As will be explained in greater detail, the upper end 20 of the body 16 of each blade 12, 14 is hooked to form a protective, unsharpened, curved outer tip 22. Set inwardly of the protective, curved outer tip 22 on each blade 12, 14 is a sharpened blade edge 23, as will be described in greater detail.

The lower end 18 of the body 16 of each blade 12, 14 includes an opening 24 formed through the thickness of the blade body. The opening 24 is preferably polygonal in shape, such as hexagonal, and receives a correspondingly polygonally-shaped rod 26 that extends between opposite, spaced apart end pieces 28 extending from and mounted to the proximate end 8 of the handle 4 of the pet grooming tool 2. The sets of forward and rear blades 12, 14 are mounted on the rod 26 by passing the rod through the polygonally-shaped openings 24 and, thereby, are situated between the supporting end pieces 28. The opposite axial ends of the rod 26 may be threaded and may pass through an opening 30 formed through the thickness of each end piece 28, and may be secured to each end piece by a nut 32. The purpose of preferably using a polygonally-shaped opening 24 in each blade 12, 14, and a correspondingly polygonally-shaped rod 26, is to prevent the blades from rotating on the pet grooming tool 2 and to maintain the blades in a particular orientation not only with respect to one another but also with respect to the angle from which they extend outwardly from the handle 4 of the pet grooming tool 2.

Of course, alternative methods for mounting the blades 12, 14 to the proximate end 8 of the handle 4 are envisioned to be within the scope of the present invention. For example, the lower ends 18 of the interleaved forward and rear blades 12, 14 may be secured directly to the proximate end 8 of the handle 4 in corresponding slots (not shown) formed therein or by being embedded in the material (such as plastic) forming the handle 4. If desired, spacers 34, such as bushings or washers, may be placed between the plurality of forward and rear blades 12, 14 and the end pieces 28 to position the blades more centrally between the end pieces 28, for example, if fewer blades 12, 14 in each set are used in the blade design.

As mentioned previously, and as shown in FIGS. 1-4, there are preferably two sets of blades, that is, a set of forward blades 12 and a set of rear blades 14, designated as such relative to the direction of movement of the blades through the animal's fur (i.e., the hooked upper ends 20, curved outer tips 22 and sharpened edges 23 of the forward blades 12 being in front, or more forward of and leading, the hooked upper ends 20, curved outer tips 22 and sharpened edges 23 of the rear blades 14 as the pet grooming tool 2 is pulled handle first through the fur of the animal). The rear blades 14 are interleaved with the forward blades 12 in an alternating fashion, as shown in the drawings. Thus, each rear blade 14 is offset laterally from its adjacent forward blade 12, and adjacent forward blades 12 and adjacent rear blades 14 are spaced apart from each other. Preferably, the body 16 of each forward and rear blade 12, 14 has a thickness of about 0.4 millimeters. Thus, the spacing between adjacent rear blades 14 is approximately equal to the thickness of the body 16 of a forward blade 12, and the spacing between adjacent forward blades 12 is approximately equal to the thickness of the body 16 of a rear blade 14.

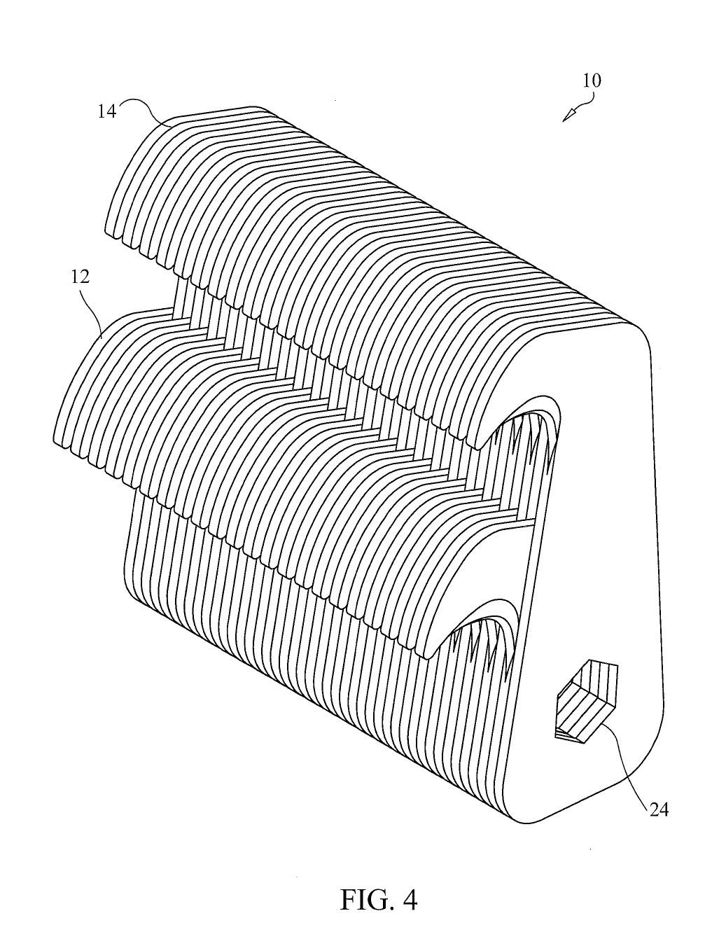

As can be seen in FIG. 4, the body 16 of each rear blade 14 is longer than the body 16 of each forward blade 12 so that the hooked end 20 of each rear blade 14 is disposed above and overhangs the hooked end 20 of each forward blade 12. As also mentioned previously, each of the forward blades 12 and rear blades 14 includes a hooked end 20 which defines an outer tip 22. This outer tip 22 is unsharpened and preferably has a curved edge. Set inwardly of the outer tip 22 on each of the front and rear blades 12, 14 is a sharpened edge 23. The sharpened edge 23 may be formed on one lateral side of the blade 12, 14 or on both lateral sides of the blade, and is situated within a pocket 36 defined by the outer tip 22 of the blade and the main body 16 of the blade. Accordingly, the outer tip 22, which is unsharpened, makes contact with the skin of the animal when the grooming tool 2 of the present invention is being used, and protects the skin from irritation or cutting, or contact with the sharpened blade edge 23.

Reference should now be had to FIG. 9 of the drawings. Here, a pair of forward and rear blades 12, 14 is illustrated, as well as a single hair 38 of the animal being groomed. As was evident from the earlier drawings and description of the blade design of the pet grooming tool 2 of the present invention, the forward and rear blades 12, 14 are offset from one another both in a forward-to-rear orientation and a side-to-side (lateral) orientation. The orientations of the forward and rear blades 12, 14 force the fur or hair 38 of the animal to assume a soft “S” shape or bend along a portion of its length as the hair passes over the rear and forward blades as the animal is being groomed. This soft “S” shape or bend of the hair 38 causes the hair to catch more easily on the inset sharpened blade edges 23 of the rear and forward blades 14, 12, which increases the efficiency in deshedding and/or dematting the fur of the animal during grooming Also, the outer tip 22 and thin surface of the bodies 16 of each of the rear and forward blades 14, 12 are preferably rounded or tapered to force the fur into the pocket 36 defined by the hooked end 20 in which the sharpened blade edge 23 resides and cause the hair 38 to follow or bend in this soft “S” shape over the sharpened edges of the blades.

As can be seen from the foregoing description, the pet grooming tool 2 and the combination blade design of the present invention work efficiently to deshed and demat the fur of an animal, such as a dog or a cat. The pet grooming tool 2 may be formed in different widths so that multiple forward and rear blade sets can be placed side-by-side to increase the surface area which comes in contact with the animal fur for deshedding or dematting the animal The soft “S” shape or bend that the hair 38 of the animal takes as it passes over the rear and forward blades 14, 12 during grooming with the pet grooming tool 2 of the present invention causes the hair to catch more easily on the inset blade edges 23. Furthermore, the unsharpened, curved outer tip 22 of the hooked end 20 of the body 16 of each forward and rear blade 12, 14 protects the skin of the animal during grooming and will not irritate or cut the skin.

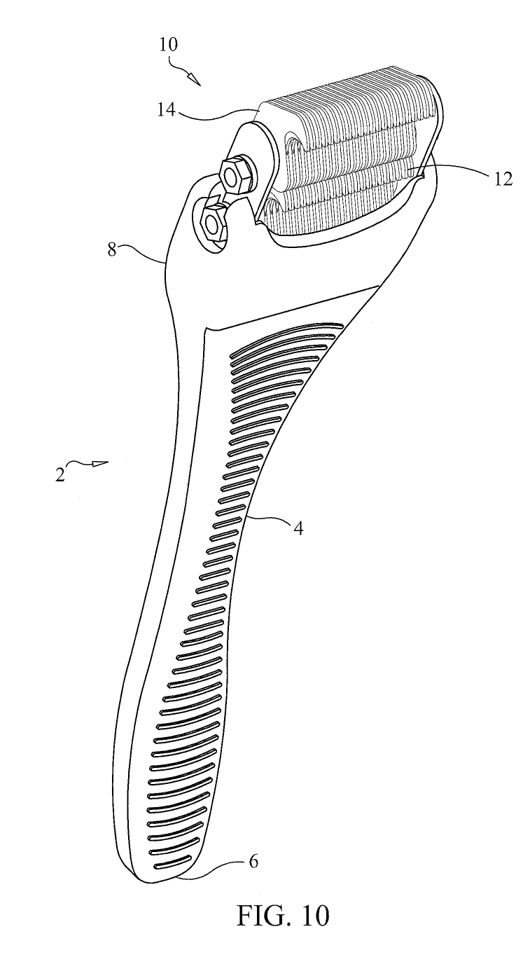

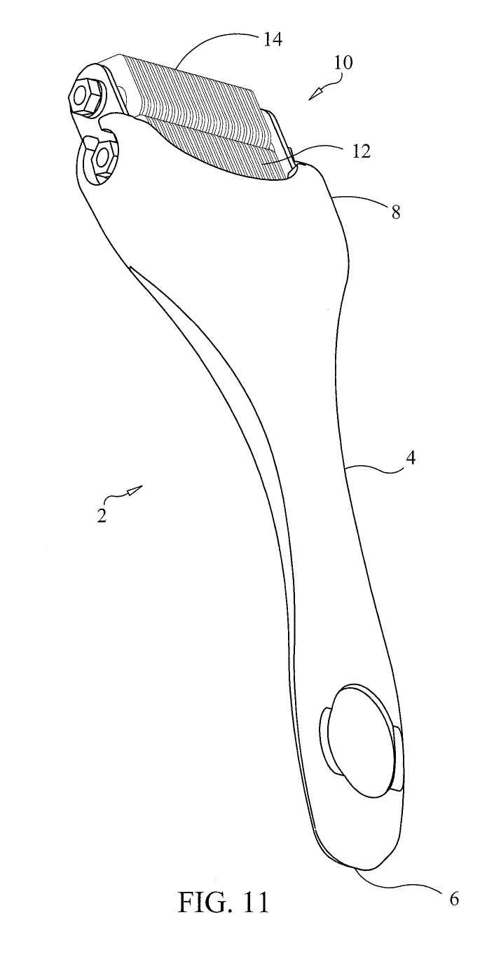

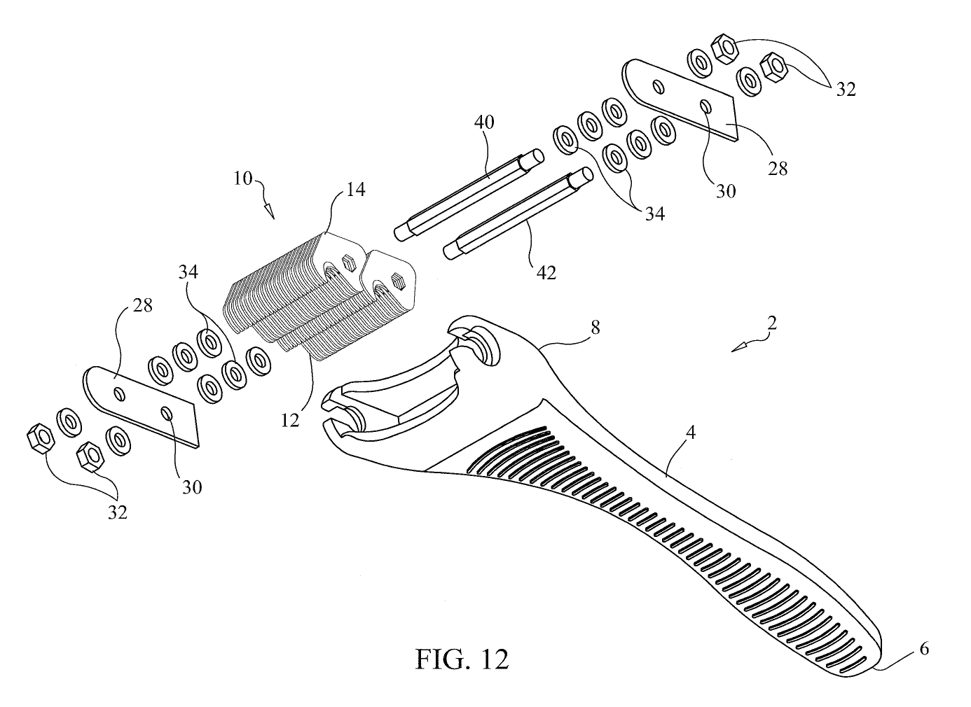

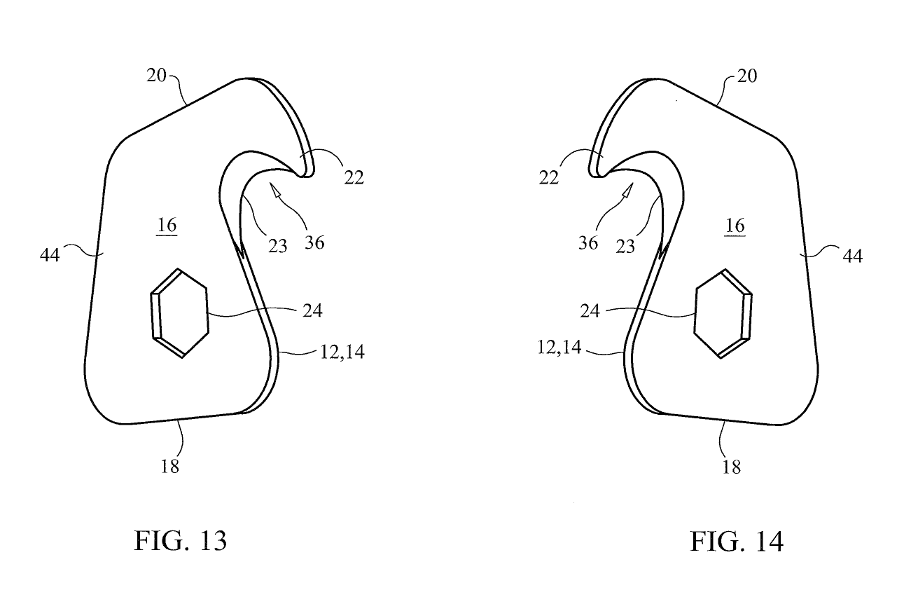

FIGS. 10-14 show an alternative form of the pet grooming device and blade design of the present invention. Here, a set of forward blades 12 and a set of rear blades 14 are mounted on the proximate end 8 of the handle 4 of the pet grooming tool 2. However, in this alternative embodiment of the pet grooming tool, the bodies 16 of the rear blades 14 and the forward blades 12 are shaped similarly. The set of rear blades 14 is mounted on a first rod 40, and the set of forward blades 12 is mounted on a second rod 42 spaced below and in parallel with the first rod 40. More specifically, the body 16 of each rear blade 14 and the body 16 of each forward blade 12 include an opening 24 formed through the thickness thereof which is preferably polygonally shaped, such as hexagonally shaped, to receive either the first rod 40 or the second rod 42 therethrough. Each of the rods 40, 42 is correspondingly polygonally shaped so that it may pass through the openings 24 in the rear blades 14 or the forward blades 12 and to prevent the blades from rotating thereon, in the same manner as the blades 12, 14 are mounted on the rod 26 in the embodiment of the pet grooming tool 2 shown in FIG. 1 and described previously. Again, each of the first and second rods 40, 42 may be threaded at its ends, and may extend between and be mounted to a pair of opposite end pieces 28 through openings 30 formed in the end pieces, and secured thereto by nuts 32. Washers, bushings or other spacers 34 may be placed on the rods 40, 42 to center the multiple blade sets on their corresponding rods.

Each of the rear blades 14 and each of the forward blades 12 includes a hooked end 20 having an unsharpened outer tip 22, as described previously with the earlier embodiment, so that the unsharpened outer tip 22 contacts the skin of the animal during grooming and protects the skin from the sharpened blade edge 23, which is inset on the body 16 of the blade inwardly from the outer tip 22 within the pocket 36 defined between the outer tip 22 and the main body 16 of the blade. The outer tips 22 or hooked ends 20 of the rear blades 14 generally overhang the outer tips 22 of the forward blades 12, as in the earlier embodiment shown in FIG. 1 and described previously.

One advantage of the second embodiment of the blade design and the pet grooming tool 2 of the present invention shown in FIGS. 10-14 is that the body 16 of each rear blade 14 and the body 16 of each forward blade 12 are shaped the same and are interchangeable, which may help to decrease the manufacturing and assembling costs of the pet grooming tool. As with the earlier embodiment shown in FIG. 1, the blades 12, 14 of the pet grooming tool shown in FIGS. 10-14 are offset in both the forward-to-rear orientation and the side-to-side (lateral) orientation to cause the fur/hair of the animal to form a soft “S” shape or bend as the tool 2 is pulled through the pet's fur during grooming. This soft “S” shape that the hair 38 takes on during grooming causes the hair to catch more easily on the inset blade edges 23 of the rear and forward blades 14, 12.

Thus, in accordance with one form of the present invention, a pet grooming tool 2 includes a handle 4, the handle 4 having a proximate end portion 8, and a blade assembly 10 mounted on the proximate end portion 8 of the handle 4, the blade assembly 10 extending in a generally longitudinal direction and in a generally lateral direction transverse to the generally longitudinal direction. The blade assembly 10 preferably includes a first set of rear blades 14 a second set of forward blades 12. Each of the rear blades 14 of the first set and the forward blades 12 of the second set has a blade body 16 that includes a main body portion 44 having a lower end portion 18 and an upper free end portion 20 situated opposite the lower end portion 18. The lower end portion 18 of each blade body 16 of the rear and forward blades 14, 12 are secured to the proximate end portion 8 of the handle 4. The upper end portion 20 of each blade body 16 of the rear and forward blades 14, 12 preferably formed with a hooked shape and has a protective, unsharpened outer tip 22. Each blade body 16 of the rear and forward blades 14, 12 further has a sharpened blade edge 23 inset from the protective outer tip 22 thereof and situated between the main body portion 44 of the blade body 16 and the protective outer tip 22.

The first set of rear blades 14 is arranged with respect to the second set of forward blades 12 so as to be interleaved with the second set of forward blades 12 such that a rear blade 14 of the first set is situated at least partially between adjacent forward blades 12 of the second set and such that the protective outer tips 22 and sharpened edges 23 of the rear blades 14 of the first set are offset both in the generally longitudinal direction of the blade assembly 10 and in the generally lateral direction of the blade assembly 10 from the protective outer tips 22 and sharpened edges 23 of the forward blades 12 of the second set.

In the pet grooming tool of the present invention, the main body portion 44 of the blade body 16 of each rear blade 14 of the first set and each forward blade 12 of the second set has a longitudinal length measured between the lower end portion 18 thereof and the upper free end portion 20 thereof. In a preferred form of the invention, the longitudinal length of the main body portion 44 of the blade body 16 of each rear blade 14 of the first set is greater than the longitudinal length of the main body portion 44 of the blade body 16 of each forward blade 12 of the second set. In another form of the pet grooming tool of the present invention, the blade body 16 of each rear blade 14 of the first set has substantially the same shape as the blade body 16 of each forward blade 12 of the second set.

In one form of the pet grooming tool of the present invention, the blade assembly 10 further includes a rod 26 mounted on the proximate end portion 8 of the handle 4 and extending in the generally lateral direction of the blade assembly 10. The lower end portion 18 of the main body portion 44 of the blade body 16 of each rear blade 14 of the first set and each forward blade 12 of the second set has formed through the thickness thereof an opening 24 to receive the rod 26, the rear blades 14 of the first set and the forward blades 12 of the second set being alternatingly mounted on the rod 26.

In the pet grooming tool of the present invention described above, the blade assembly 10 may further include a pair of spaced apart, parallelly disposed end pieces 28. The end pieces 28 of the pair of end pieces are mounted on the proximate end portion 8 of the handle 4. The rod 26 having mounted thereon the rear blades 14 of the first set and the forward blades 12 of the second set extends between and is secured to the pair of spaced apart end pieces 28.

Also, the rod 26 of the pet grooming tool described above may have a polygonal shape in cross-section, and the openings 24 formed in the rear blades 14 of the first set and the forward blades 12 of the second set which receive the rod 26 may also have a polygonal shape which conforms to the polygonal cross-sectional shape of the rod 26 to prevent the rear blades 14 of the first set and forward blades 12 of the second set from rotating relative to the rod 26. Preferably, the rod 26 has a hexagonal shape in cross-section, and the openings 24 formed in the rear blades 14 of the first set and the forward blades 12 of the second set which receive the rod 26 have a hexagonal shape.

In another preferred form of the pet grooming tool, the blade assembly 10 further includes a first rod 40 mounted on the proximate end portion 8 of the handle 4 and extending in the generally lateral direction of the blade assembly 10. The lower end portion 18 of the main body portion 44 of the blade body 16 of each rear blade 14 of the first set has formed through the thickness thereof a first opening 24 to receive the first rod 40. The rear blades 14 of the first set are mounted on the first rod 40.

In this embodiment, the blade assembly 10 further includes a second rod 42 mounted on the proximate end portion 8 of the handle 4 and extending in the generally lateral direction of the blade assembly 10. The second rod 42 is disposed parallel to and spaced apart from the first rod 40. The lower end portion 18 of the main body portion 44 of the blade body 16 of each forward blade 12 of the second set has formed through the thickness thereof a second opening 24 to receive the second rod 42. The forward blades 12 of the second set are mounted on the second rod 42.

In this two-rod version of the pet grooming tool, the first rod 40 is spaced apart from the second rod 42 a predetermined distance such that a portion of the upper end portion 20 of each forward blade 12 of the second set mounted on the second rod 42 overlaps longitudinally a portion of the lower end portion 18 of each rear blade 14 of the first set and such that a portion of the lower end portion 18 of a rear blade 14 of the first set is received between the upper end portions 20 of adjacent forward blades 12 of the second set, and a portion of the upper end portion 20 of a forward blade 12 of the second set is received between the lower end portions 18 of adjacent rear blades 14 of the first set.

In the two-rod version of the pet grooming tool described above, the blade assembly 10 may further include a pair of spaced apart, parallelly disposed end pieces 28. The end pieces 28 of the pair of end pieces are mounted on the proximate end portion 8 of the handle 4. The first rod 40 having mounted thereon the rear blades 14 of the first set and the second rod 42 having mounted thereon the forward blades 12 of the second set extend between and are secured to the pair of spaced apart end pieces 28.

In a preferred version of the two-rod pet grooming tool, each of the first rod 40 and the second rod 42 has a polygonal shape in cross-section, and the first openings 24 formed in the rear blades 14 of the first set which receive the first rod 40 and the second openings 24 formed in the forward blades 12 of the second set which receive the second rod 42 have a polygonal shape which respectively conform to the polygonal cross-sectional shapes of the first and second rods 40, 42 to prevent the rear blades 14 of the first set from rotating relative to the first rod 40 and to prevent the forward blades 12 of the second set from rotating relative to the second rod 42. Preferably, each of the first rod 40 and the second rod 42 has a hexagonal shape in cross-section, and the first openings 24 formed in the rear blades 14 of the first set which receive the first rod 40 and the second openings 24 formed in the forward blades 12 of the second set which receive the second rod 42 have a polygonal shape.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A pet grooming tool, which comprises:
a handle, the handle having a proximate end portion; and
a blade assembly mounted on the proximate end portion of the handle, the blade assembly extending in a generally longitudinal direction and in a generally lateral direction transverse to the generally longitudinal direction, the blade assembly including:
a first set of rear blades and a second set of forward blades, each of the rear blades of the first set and the forward blades of the second set having a blade body including a main body portion having a lower end portion and an upper free end portion situated opposite the lower end portion, the lower end portion of each blade body of the rear and forward blades being secured to the proximate end portion of the handle, the upper end portion of each blade body of the rear and forward blades being formed with a hooked shape and having a protective, unsharpened outer tip, each blade body of the rear and forward blades further having a sharpened blade edge inset from the protective outer tip thereof and situated between the main body portion of the blade body and the protective outer tip;
wherein the first set of rear blades is arranged with respect to the second set of forward blades so as to be interleaved with the second set of forward blades such that a rear blade of the first set is situated at least partially between adjacent forward blades of the second set and such that the protective outer tips and sharpened edges of the rear blades of the first set are offset both in the generally longitudinal direction of the blade assembly and in the generally lateral direction of the blade assembly from the protective outer tips and sharpened edges of the forward blades of the second set.

2. A pet grooming tool as defined by claim 1, wherein the main body portion of the blade body of each rear blade of the first set and each forward blade of the second set has a longitudinal length measured between the lower end portion thereof and the upper free end portion thereof, the longitudinal length of the main body portion of the blade body of each rear blade of the first set being greater than the longitudinal length of the main body portion of the blade body of each forward blade of the second set.

3. A pet grooming tool as defined by claim 1, wherein the blade body of each rear blade of the first set has substantially the same shape as the blade body of each forward blade of the second set.

4. A pet grooming tool as defined by claim 1, wherein the blade assembly further includes a rod mounted on the proximate end portion of the handle and extending in the generally lateral direction of the blade assembly, and wherein the lower end portion of the main body portion of the blade body of each rear blade of the first set and each forward blade of the second set has formed through the thickness thereof an opening to receive the rod, the rear blades of the first set and the forward blades of the second set being alternatingly mounted on the rod.

5. A pet grooming tool as defined by claim 4, wherein the blade assembly further includes a pair of spaced apart, parallelly disposed end pieces, the end pieces of the pair of end pieces being mounted on the proximate end portion of the handle, and wherein the rod having mounted thereon the rear blades of the first set and the forward blades of the second set extends between and is secured to the pair of spaced apart end pieces.

6. A pet grooming tool as defined by claim 4, wherein the rod has a polygonal shape in cross-section, and wherein the openings formed in the rear blades of the first set and the forward blades of the second set which receive the rod have a polygonal shape which conforms to the polygonal cross-sectional shape of the rod to prevent the rear blades of the first set and forward blades of the second set from rotating relative to the rod.

7. A pet grooming tool as defined by claim 6, wherein the rod has a hexagonal shape in cross-section, and wherein the openings formed in the rear blades of the first set and the forward blades of the second set which receive the rod have a hexagonal shape.

8. A pet grooming tool as defined by claim 1, wherein the blade assembly further includes a first rod mounted on the proximate end portion of the handle and extending in the generally lateral direction of the blade assembly, and wherein the lower end portion of the main body portion of the blade body of each rear blade of the first set has formed through the thickness thereof a first opening to receive the first rod, the rear blades of the first set being mounted on the first rod; and
wherein the blade assembly further includes a second rod mounted on the proximate end portion of the handle and extending in the generally lateral direction of the blade assembly, the second rod being disposed parallel to and spaced apart from the first rod, and wherein the lower end portion of the main body portion of the blade body of each forward blade of the second set has formed through the thickness thereof a second opening to receive the second rod, the forward blades of the second set being mounted on the second rod; and
wherein the first rod is spaced apart from the second rod a predetermined distance such that a portion of the upper end portion of each forward blade of the second set mounted on the second rod overlaps longitudinally a portion of the lower end portion of each rear blade of the first set and such that a portion of the lower end portion of a rear blade of the first set is received between the upper end portions of adjacent forward blades of the second set, and a portion of the upper end portion of a forward blade of the second set is received between the lower end portions of adjacent rear blades of the first set.

9. A pet grooming tool as defined by claim 8, wherein the blade assembly further includes a pair of spaced apart, parallelly disposed end pieces, the end pieces of the pair of end pieces being mounted on the proximate end portion of the handle, and wherein the first rod having mounted thereon the rear blades of the first set and the second rod having mounted thereon the forward blades of the second set extend between and are secured to the pair of spaced apart end pieces.

10. A pet grooming tool as defined by claim 8, wherein each of the first rod and the second rod has a polygonal shape in cross-section, and wherein the first openings formed in the rear blades of the first set which receive the first rod and the second openings formed in the forward blades of the second set which receive the second rod have a polygonal shape which respectively conform to the polygonal cross-sectional shapes of the first and second rods to prevent the rear blades of the first set from rotating relative to the first rod and to prevent the forward blades of the second set from rotating relative to the second rod.

11. A pet grooming tool as defined by claim 10, wherein each of the first rod and the second rod has a hexagonal shape in cross-section, and wherein the first openings formed in the rear blades of the first set which receive the first rod and the second openings formed in the forward blades of the second set which receive the second rod have a polygonal shape.
